(19) United States
(12) Patent Application Publication
(10) Pub. No.: US 2013/0000976 A1
(43) Pub. Date: Jan. 3, 2013

(54) CABLE ASSEMBLY

(75) Inventors: Po-Wen CHIU, Tu-Cheng (TW); Wen-Hu LU, Shenzhen City (CN); Zhan-Yang LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (TW)

(21) Appl. No.: 13/444,102

(22) Filed: Apr. 11, 2012

(30) Foreign Application Priority Data
Jun. 30, 2011 (CN) 201110181516.7

(51) Int. Cl. H02G 15/02; F16L 3/10

(52) U.S. Cl. 174/75 R; 248/65

(57) ABSTRACT

A cable assembly includes a cable and a cable securing member. The cable includes a metal portion and an insulation surrounding the metal portion. The metal portion includes a connecting end exposed out of the insulation. The cable securing member defines a securing hole. A first receiving opening and a second receiving opening are defined in the cable securing member. The first receiving opening is aligned with the second receiving opening. The first receiving opening is greater than the second receiving opening. The first receiving opening receives the insulation. The second receiving opening receives the connecting end.

### CROSS-REFERENCE TO RELATED APPLICATIONS

This application claims all benefits accruing under 35 U.S.C. §119 from China Patent Application No. 201110181516.7, filed on 2011 Jun. 30 in the China Intellectual Property Office, the disclosure of which is incorporated herein by reference. This application is related to co-pending U.S. Patent Application entitled “CABLE MOUNTING APPARATUS”, Attorney Docket No. US39838, U.S. application Ser. No. ______ filed on ______.

### BACKGROUND

1. Technical Field

The disclosure relates to cable assemblies.

2. Description of Related Art

There are many cables or wires used in computers for power output and data transmission. The cable includes a metal portion and a plastic surface surrounding the metal portion. Some cables are secured to an element by enlacing the metal portion to the element, which is time-consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a cable assembly of an embodiment.

FIG. 2 is an isometric view of a cable securing member of FIG. 1.

FIG. 3 is an isometric view of a mounting member of FIG. 1.

FIG. 4 is an assembly view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

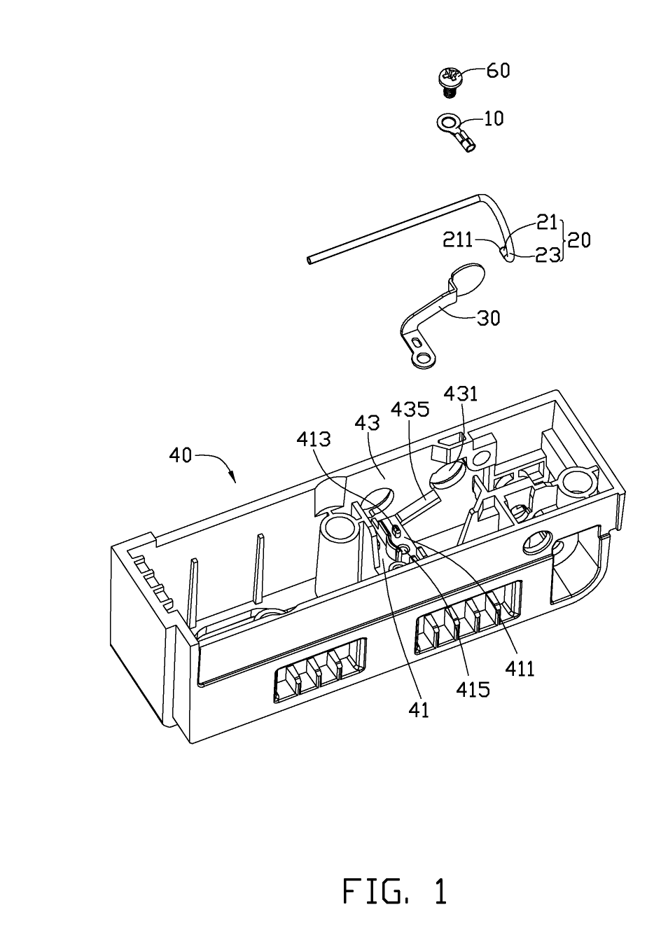

Referring to FIG. 1, a cable assembly includes a cable securing member 10, a cable 20, a mounting member 30, and a mounting bracket 40.

The cable 20 includes a metal portion 21 and an insulation 23 covering nearly the entire metal portion 21. The metal portion 21 includes a connecting end 211 exposed out of the insulation 23.

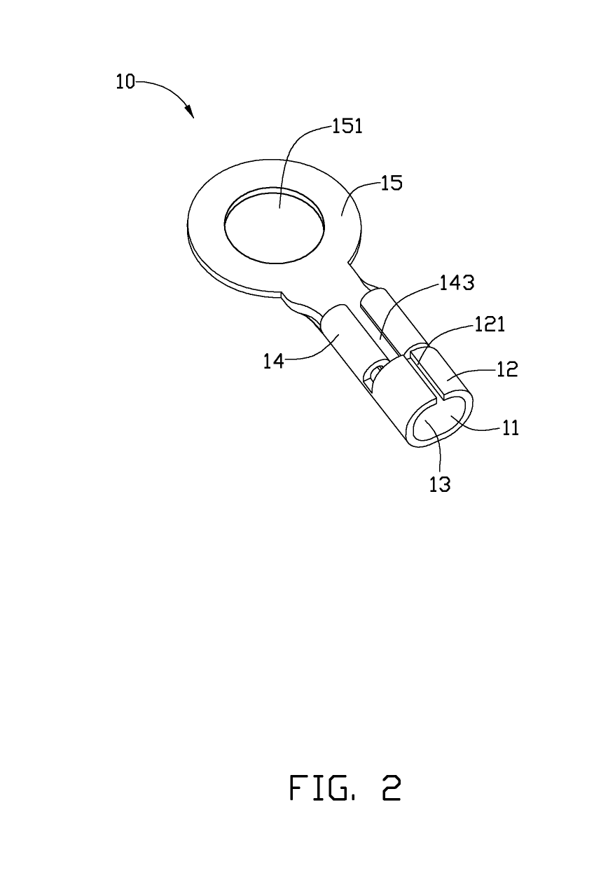

Referring to FIG. 2, the cable securing member 10 includes a base portion 11 and two mounting tabs 12 extending from opposite sides of the base portion 11. The cross-section of the base portion 11 taken along a plane is substantially arc-shaped. The cross-section of each mounting tab 12 taken along the plane is substantially arc-shaped. A slot 121 is defined between the two mounting tabs 12. A first receiving opening 13 is defined by the two mounting tabs 12 and the base portion 11. The securing member 10 further includes two securing portions 14 extending from the base portion 11. The cross-section of each securing portion 14 taken along the plane is substantially arc-shaped. A second receiving opening 143 is defined by the two securing portions 14 and the base portion 11. The second receiving opening 143 is aligned with the first receiving opening 13 and smaller than the first receiving opening 13. A radius of the cross-section of the mounting tab 12 is greater than a radius of the cross-section of the securing portion 14. The securing member 10 further includes a securing tab 15 extending from the base portion 11. The securing tab 15 is substantially circular and defines a securing hole 151. The axis surrounded by the base portion 11 is substantially parallel to the axis surrounded by the mounting tabs 12 and the axis surrounded by the securing portions 14.

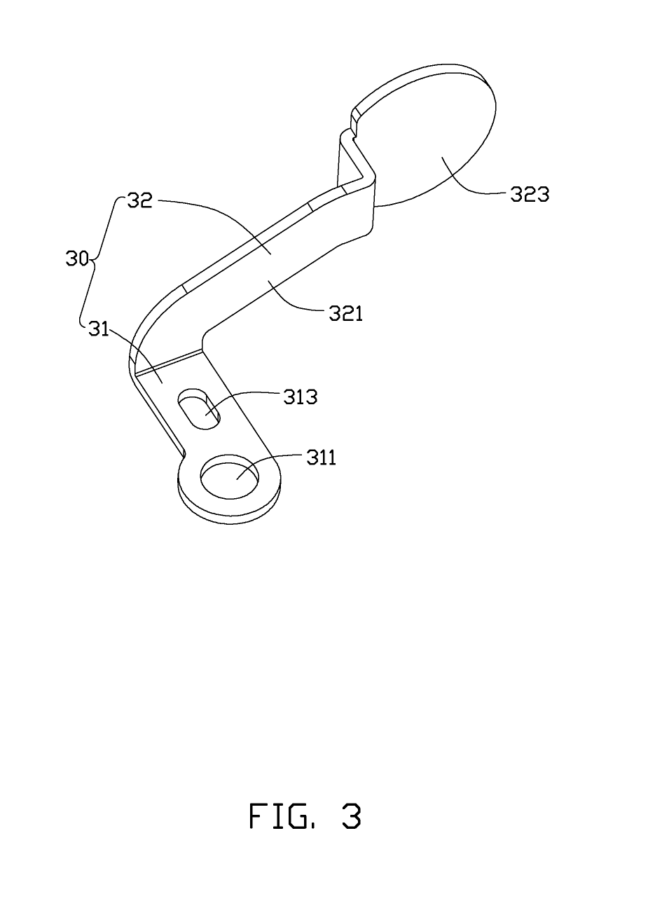

Referring to FIG. 3, the mounting member 30 includes a positioning tab 31 and a conducting tab 32 extending from the positioning tab 31. The positioning tab 31 defines a mounting hole 311 corresponding to the securing hole 151 and a positioning hole 313. The conducting tab 32 includes a connecting portion 321 connected to the positioning tab 31 and a circular conducting portion 323 extending from the connecting portion 321. In one embodiment, the mounting member 30 is made of metal.

The mounting bracket 40 includes a mounting panel 41 and a side panel 43 extending from the mounting panel 41. The side panel 43 is substantially perpendicular to the mounting panel 41. The mounting panel 41 includes a panel body 411 and a positioning portion 413 extending from the panel body 411. The positioning portion 413 corresponds to the positioning hole 313. The mounting panel 41 defines a through hole 415 corresponding to the mounting hole 311 of the mounting member 30. The side panel 43 defines a mounting opening 431 used for receiving the conducting portion 323. The side panel 43 includes a protrusion 435 used for supporting the connecting portion 321.

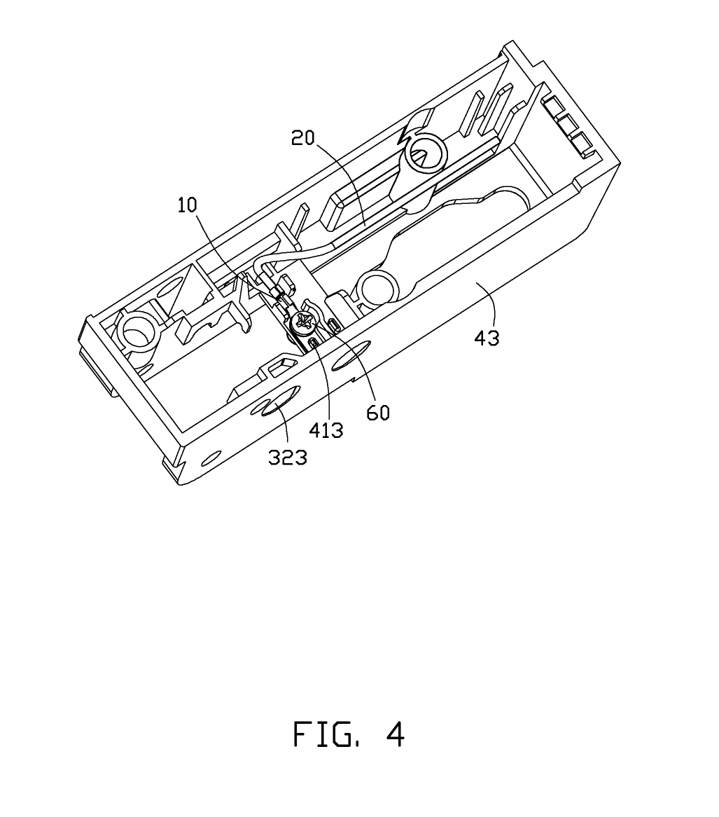

Referring to FIGS. 1 to 4, in assembly, the cable 20 is inserted into the first receiving opening 13 of the securing member 10 until the connecting end 211 is received in the second receiving opening 143. The mounting tab 12 resists the insulation 23 of the cable 20. The connecting end 211 is secured in the second receiving opening 143 to secure the cable 20 to the cable securing member 10. The mounting hole 311 of the mounting member 30 is aligned with the through hole 415 of the mounting bracket 40. The positioning portion 413 of the mounting bracket 40 is located in the positioning hole 313. The conducting portion 323 of the mounting member 30 is received in the mounting opening 431 of the mounting bracket 40. The protrusion 435 supports the connecting portion 321 of the mounting member 30. The positioning portion 413 can be secured to the positioning hole 313 by melting the positioning portion 413. A fastener 60, such as a screw, is secured into the securing hole 151 of the cable securing member 10, the mounting hole 311 of the mounting member 30, and the through hole 415 of the mounting bracket 40 to secure the cable 20 to the mounting bracket 40. A sensing device (not shown) can be connected to the conducting portion 323 of the mounting member 30 to sense the signal on the cable 20.

In disassembly, the fastener 60 is disassembled from the mounting bracket 40, thereby the cable 20 can be easily removed from the mounting bracket 40.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cable assembly, comprising:
a cable, the cable comprising a metal portion and an insulation surrounding the metal portion, the metal portion comprising a connecting end exposed out of the insulation; and
a cable securing member, the cable securing member defining a securing hole, wherein a first receiving opening and a second receiving opening are defined in the cable securing member; the first receiving opening is aligned with the second receiving opening; the first receiving opening is greater than the second receiving opening; the first receiving opening receives the insulation; and the second receiving opening receives the connecting end.

2. The cable assembly of claim 1, wherein the cable securing member comprises a base portion, two mounting tabs extend from opposite sides of the base portion, and two securing portions extend from opposite sides of the base portion; the first receiving opening is defined by the base portion and the two mounting tabs; and the second receiving opening is defined by the base portion and the two securing portions.

3. The cable assembly of claim 2, wherein a slot is defined between the two mounting tabs.

4. The cable assembly of claim 2, wherein a cross-section of each mounting tab taken along a plane is arc-shaped; and a cross-section of the base portion taken along the plane is arc-shaped.

5. The cable assembly of claim 4, wherein a cross-section of each securing portion taken along the plane is arc-shaped.

6. The cable assembly of claim 5, wherein a radius of the cross-section of the mounting tab is greater than a radius of the cross-section of the securing portion.

7. The cable assembly of claim 1, further comprising a mounting bracket, wherein the cable securing member further comprises a securing tab extending from the base portion;
a securing hole is defined in the securing tab; and a through hole is defined in the mounting bracket corresponding to the securing hole.

8. A cable securing member, comprising:
a base portion;
two mounting tabs extending from opposite sides of the base portion; and
two securing portions extending from opposite sides of the base portion;
wherein a first receiving opening is defined by the base portion and the two mounting tabs; a second receiving opening is defined by the base portion and the two securing portions; and the first receiving opening and the second receiving opening are configured to receive a cable.

9. The cable securing member of claim 8, wherein a slot is defined between the two mounting tabs.

10. The cable securing member of claim 8, wherein a cross-section of each mounting tab taken along a plane is arc-shaped; and a cross-section of the base portion taken along the plane is arc-shaped.

11. The cable securing member of claim 10, wherein a cross-section of each securing portion taken along the plane is arc-shaped.

12. The cable securing member of claim 11 wherein a radius of the cross-section of the mounting tab is great than a radius of the cross-section of the securing portion.
